(19) United States
(12) Patent Application Publication
(10) Pub. No.: US 2017/0347674 A1
(43) Pub. Date: Dec. 7, 2017

(54) PROCESS FOR PREPARING A PRODUCT COMPRISING A GELLED COMPOSITION

(71) Applicant: COMPAGNIE GERVAIS DANONE, Paris (FR)

(72) Inventors: Stephane CANTAIS, Antony (FR); Fabienne DELOFFRE, Villebon Sur Yvette (FR)

(21) Appl. No.: 15/534,806

(22) PCT Filed: Dec. 11, 2014
(86) PCT No.: PCT/IB2014/003063

§ 371 Date: Jun. 9, 2017

(51) Int. Cl. A23C 9/133; A23L 9/10; A23C 9/137; A23L 19/00; A23L 21/12; A23P 20/20

(52) U.S. Cl. CPC A23C 9/133; A23L 21/12; A23P 20/20; A23C 9/137; A23L 19/09; A23L 9/12; A23C 2270/05; A23V 2002/00

(57) ABSTRACT

Disclosed is a process for preparing a food product having a gelled layer. The process involves heating a heat-activable gelling composition.

The invention relates to a process for preparing a food product having a gelled layer.

Multilayer food products comprising a lower layer of a fruit preparation comprising fruit pieces, such as a fruit puree or jam, and an upper layer of yogurt, are appreciated by consumers. Such products are typically referred to as “fruit on the bottom”. In these products the fruit preparation is a more or less viscous composition, different from a gel. For example the consumer cannot perceive mechanical resistance when a spoon meets the fruit preparation, and cannot perceive mechanical resistance in mouth. Also the fruit pieces can be immediately perceived in mouth upon oral introduction of the fruit preparation portion. Meanwhile gelled products, such as jellies, are also a kind of products that are appreciated by consumers, for example for the texture in mouth.

There is a need for different products, providing different experiences for consumers. There is also a need for processes for making such products, including at industrial scale, with an appropriate efficiency and/or cost, in particular as to equipments needed and as to productivity.

Document EP 931463 describes a water jelly product comprising a container and a gelled composition having fruit pieces and an aqueous gelled matrix. The gelling matrix comprises sugars and xanthan gum and carrageenan, or xanthan gum and carrageenan and locust bean gum, or xanthan gum and gellan gum. The preparation process involves mixing the gelling matrix at 70° C. and fruit pieces at 10-20° C., heating to a temperature above 70° C., and filling at 70° C., sealing, and then cooling to refrigerator temperature. This process does not allow any modification, and does not allow dosing further masses, as the viscosity at 70° C. is expected to be low, which would create protections on the container. There is a need for other processes to provide products having a gelled composition in a container.

Document WO 94/02030 discloses gels formation triggered by admixing a composition comprising carrageenan and a composition comprising ions just before packaging in a flexible container. The process involves combination at a temperature of slightly above 46° C., filling the composition in a packaging, and then allowing to gel. This process is however complex, difficult to control, and does not allow dosing further separated masses. There is a need for other processes to provide products having a gelled composition in a container.

Document U.S. Pat. No. 4,752,489 discloses a process of making a composition comprising fruit pieces in a gelled matrix. Fruit pieces are introduced in a can, then a gelling composition is poured onto the pieces at a temperature of 45-50° C. The can in then heated at 53-58° C. and then allowed to cool in 24 h to a temperature of from 24 hours. This process requires long treatment times and is not adapted to allow dosing further separated masses. There is a need for other processes to provide products having a gelled composition in a container.

Document WO 02/06658 discloses gelled shaped food products. The process for making these products comprises a step of heating an aqueous gelling composition comprising a fruit juice, pectin, carrageenan and starch to a temperature of about 80° C., pouring the composition in a mold at this temperature. The composition is then allowed to dry for a period of 12 hours. This process requires long treatment times and is not adapted to allow dosing further separated masses. There is a need for other processes to provide products having a gelled composition in a container.

Document EP 334466 discloses a process of making a gelled composition involving mixing a first composition comprising proteins and a second composition comprising xanthan gum and carrageenan, at a temperature of about 55° C. and then allowing to cool to 10° C. in a refrigerator. This process requires long treatment times and is not adapted to allow dosing further separated masses. There is a need for other processes to provide products having a gelled composition in a container.

The invention addresses at least one of the needs and/or problems mentioned above with a process for preparing a product comprising a container and in the container a food composition comprising a gelled composition comprising a gelled matrix and optionally fruit, preferably in the form of fruit pieces, said process comprising the following steps:

Step a) providing a heat-activable gelling composition comprising a heat-activable aqueous gelling matrix composition and from 0 to 180 parts by weight of fruit, preferably in the form of fruit pieces, preferably from 20 to 90 parts by weight, for 60 parts by weight of the heat-activable aqueous gelling matrix, at a temperature T₀,
Step b) heating the heat-activable gelling composition to a temperature T₁>T₀, to activate gelling,
Step c) cooling the composition to a temperature T₂,
Step d) dosing a volume of the activated composition in the container at temperature T₂, to obtain a lower layer,
Step e) dosing a volume of another composition in the container, to obtain an upper layer,
Step f) optionally further cooling to a final temperature T_{f}, and/or allowing a gelling time, to obtain a lower layer gelled composition,
wherein:
the heat-activable aqueous gelling matrix composition is such that:
G′_{Tf}>G′_{T0}
wherein G′_{T0} is the elastic modulus before heating, at temperature T₀, and G′_{Tf} is the elastic modulus at final temperature T_{f} after cooling.

The invention also concerns the products that can be obtained by the process. The invention also concerns the use of the heat-activable gelling composition, or components thereof, in the process and/or products. The invention also concerns the gelled compositions.

The process of the invention allows, inter-alia, making multilayered products having the gelled layer, in conventional industrial lines, without needs for significant further investments. The sequential dosing of the compositions can be performed quickly, avoiding thus long gelling periods of time usually implemented in making gelled products. In particular the sequential dosing steps can be performed without resulting in projection of the lower layer and/or with allowing a substantially plane interface between the layers.

### Definitions

In the present specification the viscosity refers to the viscosity as measured at 10° C. (unless otherwise provided), at a shear rate of 64 s⁻¹, preferably after 10 s at this shear rate, preferably with a rheometer with 2 co-axial cylinders, for example with a Mettler® RM 180 or 200.

In the present application a gelling composition refers to a composition that has the ability to gel or increase one of its gel strength parameters in a later stage. A gelling composition has typically, at the considered temperature, a form different from a gel, typically the form of a pumpable fluid with a viscosity of less than 2000 mPa·s, preferably less than 1000 mPa·s, with low gel strength parameter(s). It might also be referred to a “gellable” composition. Gel strength parameters include, in the present application, gel strength that can be measured with a texture analyzer or to the loss modulus G″ and/or to the elastic modulus G′.

In the present application a gelling matrix refers to a matrix composition that has the ability to gel or increase its gel strength in a later stage. A gelling matrix has typically, at the temperature considered, a form different than a gel, typically the form of a pumpable fluid with a viscosity of less than 2000 mPa·s, preferably less than 1000 mPa·s, with a low gel strength parameter(s). It might also be referred to a “gellable” matric composition.

In the present application a “matrix composition” refers to a substantially continuous part of composition. For example the matrix of a composition having pieces inclusions corresponds to the composition without the pieces inclusions. If a composition does not present inclusions, then the matrix composition is the composition itself.

In the present application a gelling agent refers to an ingredient that has the ability to allow the formation of a gel, or to allow an increase of at least 10% of a gel strength parameter, when it is introduced and/or processed in a gelling composition.

In the present application a viscosity agent refers to an ingredient that has the ability to allow an increase of at least 10% of viscosity, when it is introduced and/or processed in a gelling composition.

### Product

The product made by the process of the invention comprises a container, and in the container a food composition.

The container has typically a bottom, an opening opposite to the bottom, and side walls between the bottom and the opening. The side walls can have a cylinder or conical form, with a substantially circular, oval, square, rectangular cross section.

The container can be for example a cup. The container can be for example a container of 50 ml (or 50 g) to 80 ml (or 80 g), or 80 ml (or 80 g) to 100 ml (or 100 g), or 100 ml (or 100 g) to 125 ml (or 125 g), or 125 ml (or 125 g) to 150 ml (or 150 g), or 150 ml (or 150 g) to 200 ml (or 200 g), or 200 ml (or 200 g) to 250 ml (or 250 g), or 250 ml (or 250 g) to 300 ml (or 300 g), or 300 ml (or 300 g) to 500 ml (or 500 g), or 500 ml (or 500 g) to 750 ml (or 750 g), or 750 ml (or 750 g) to 1 L (or 1 kg). The container, with the food composition inside, is typically sealed, for example with a cap or with a lid. The sealing is preferably a thermosealed lid. The container can be made of a plastic material. In a particular embodiment the container is a transparent plastic container, optionally provided with a banderole. The banderole can cover at least an upper part of the container. In one embodiment the banderole completely covers the side walls of the container. In one embodiment the banderole covers partially the side walls of the container, preferably from the top of the container to an intermediate position such that a lower layer of the food composition is visible. In one embodiment the intermediate position of the banderole is such that a lower layer of the food composition and the interface with an upper layer of the food composition can be seen. The process of the invention avoiding projections and/or allowing a substantially plane interface thus allows to save banderole material as there is no need to hide projections and/or to hide the interface.

The food composition preferably has a volume of from 80% to 100% of the maximum volume of the container.

The food composition is a multilayer composition, with a lower layer at the bottom of the container, and at least one upper layer above the lower layer. In a preferred embodiment, the food composition is a bi-layer composition, having a lower layer, and a single upper layer. The lower layer preferably represents from 5% to 50% by weight of the food composition, preferably from 10% to 30%. Preferably the interface between the lower layer and to upper layer is located at an altitude (starting from the bottom) of from 5% to 50% of the height of the container (altitude to the opening), preferably from 10% to 30%. The lower layer is a gelled composition, further detailed below. The upper layer(s) comprise(s) another composition, further detailed below.

In a preferred embodiment, the food composition has:
at the bottom of the container, a lower layer of a gelled composition comprising an aqueous gelled matrix composition and from 0 to 180 parts of fruit, preferably in the form of fruit pieces, preferably from 20 to 90 parts, for 60 parts of the aqueous gelled matrix, and
above the lower layer, another composition, preferably a fermented dairy composition.

### Gelling Composition—Gelled Composition

The gelled composition is obtained from a gelling composition. The gelling composition is dosed in the container at step d). The gel is formed from the gelling composition at a further stage.

The gelled composition and the gelling composition comprise a matrix and optionally fruit, preferably in the form of pieces. Preferably the gelled composition and the gelling composition comprise, for 60 parts by weight of matrix, from 0 part by weight (0% by weight of total composition) to 180 parts by weight (75% by weight of total composition), preferably from 20 parts by weight (25% by weight of total composition) to 90 parts by weight (60% by weight of total composition).

The fruit in the gelled or gelling composition can be for example:
frozen fruit cubes, for example 10 mm fruit cubes, for example Individual Quick Frozen fruit cubes, for example strawberry, peach, apricot, mango, apple or pear fruit cubes or mixtures thereof,
aseptic fruit cubes, for example 10 mm fruit cubes, for example strawberry, peach, apricot, mango, apple or pear fruit cubes or mixtures thereof,
fruit purees, for example fruit purees concentrated from 2 to 5 times, preferably 3 times, for example aseptic fruit purees, for example strawberry, peach, apricot, mango, raspberry, blueberry or apple fruit purees or mixtures thereof,
single aseptic fruit purees, for example strawberry, raspberry, peach, apricot, blueberry or apple single aseptic fruit purees or mixture thereof,
frozen whole fruits, for example Individual Quick Frozen whole fruits, for example blueberry, raspberry or blackberry frozen whole fruits, or mixtures thereof, or
mixtures thereof.

The invention finds particular advantages, especially as to organoleptic properties with firm and/or juicy fruits. It has been found that the process of the invention allows a good maintenance of the firmness and/or the juiciness, this being particularly marked for example with strawberry, pineapple, pear, apple, peach, apricot, blueberry or cherry fruit pieces.

The ingredients and/or components of the gelling or gelled composition and the amounts thereof are typically such that the composition has a brix degree of from 1 to 65 brix, for example from 1 to 10 brix, or from 10 to 15 brix, or from 15 to 20 brix, or from 20 to 25 brix, or from 25 to 30 brix, or from 30 to 35 brix, or from 35 to 40 brix, or from 40 to 45 brix, or from 45 to 50 brix, or from 50 to 55 brix, or from 55 to 60 brix, or from 55 to 60 brix, or from 60 to 65 brix.

### Gelling Matrix—Gelled Matrix

The gelled matrix composition is obtained from a heat-activable aqueous gelling matrix composition.

The gelling matrix composition typically comprises water and other ingredients, preferably rheology modifying agents, such that the matrix composition has a rheology profile as described below. The ingredients, including their chemical composition and amounts, are typically selected such that the rheology profile is met. The rheology profile can be established and/or determined on the composition before implementing the process of the invention, without the fruit.

### Rheology Profile

The matrix composition is heat-activable: the rheology of the composition is different after the heating step than before, preferably with higher gel strength parameter(s) after heating than before, typically at the same temperature evaluation, preferably at a temperature below T₂, for example at a temperature of from 4° C. to 10° C. The heat-activable aqueous gelling matrix composition is such that:
G′_{Tf}>G′_{T0}
wherein G′_{T0} is the elastic modulus before heating, at temperature T₀, G′_{Tf} is the elastic modulus at final temperature T_{f} after cooling.

Typically the matrix composition presents a heat-activation temperature T_{act} for which: upon heating and then cooling, there is, at the same starting and final temperature, an increase of some gel strength parameter(s), preferably with at least a factor of at least 1.2, at the final cooling temperature, if heating is performed beyond T_{act}, whereas such an increase is not observed if heating is performed below T_{act}. For example T_{act} can be comprised between 35° C. and 75° C., preferably between 40° C. and 55° C.

Optionally the matrix composition presents a transition temperature Tₜᵣₐₙₛ below which the increase of the gel strength parameter is observed upon cooling.

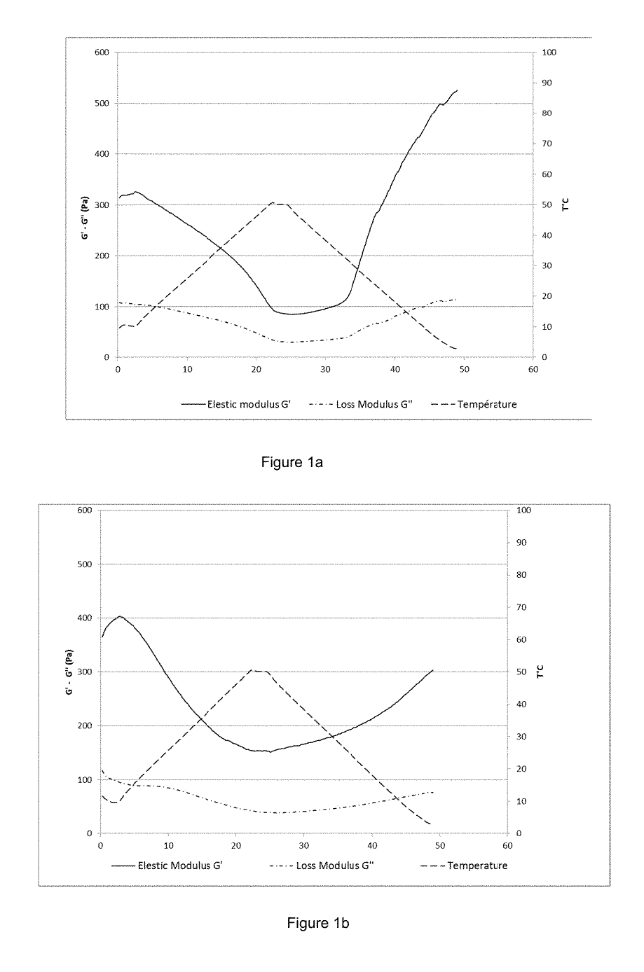

A rheology profile of a matrix composition that can be used is for example presented on FIG. 1a: at an initial temperature T₀ (here 10° C.), the composition has an elastic modulus G′_{T0} (here about 320 mPa·s) and a loss modulus G″_{T0} (here about 110 mPa·s). Upon heating to a maximum temperature (here to a temperature of 50° C.), the elastic modulus and the loss modulus decrease. Upon cooling the loss modulus slightly increases, and the elastic modulus sees a very significant increase. At final temperature T_{f} (here 3° C.), the composition has an elastic modulus G′_{Tf} (here about 520 mPa·s) and a loss modulus G″_{Tf} (here about 110 mPa·s). The elastic modulus at final temperature G′_{Tf} is much higher than the elastic modulus at initial temperature G′_{T0}. Therefore there is an activation temperature T_{act} which is below the maximum temperature. There is transition temperature (here about 20° C.) below which the elastic modulus is higher than the initial elastic modulus G′_{T0}.

In one embodiment:
G′_{Tf}/G″_{Tf}≧4
wherein G″_{Tf} is the loss modulus at final temperature T_{f} after cooling.

In a preferred embodiment, there is temperature at which, upon cooling, the composition has a significant viscosity, for example at least 650 mPa·s, preferably at least 750 mPa·s, while not having reached a significant gelling. Typically this temperature is higher than the transition temperature T_{Trans}. Preferably there is a temperature T′₂ upon cooling for which:
V_{T′2}>650 mPa·s, preferably V_{T′2}>750 mPa·s,
wherein V_{T′2} is the viscosity at temperature T′₂.

In a preferred embodiment:
G′_{T0}/G″_{T0}<4, preferably G′_{T0}/G″ _{T0}<3.5,
wherein G′_{T0} is the elastic modulus at temperature T₀ before heating, and G″_{T0} is the loss modulus at temperature T₀ before heating.

In a preferred embodiment:
(G′_{Tf}/G″_{Tf})/(G′_{T0}/G″_{T0})≧1.2,
wherein G″_{Tf} is the loss modulus at final temperature T_{f} after cooling and G″_{T0} is the loss modulus at temperature T₀ before heating.

### Ingredients

The aqueous gelling matrix or gelled matrix typically comprises water, rheology modifying agent(s), optionally organoleptic modifiers, and optionally other ingredients. The organoleptic modifiers and other ingredients can be those that are typically used in fruit preparations, known by the one skilled in the art.

The rheology modifying agent(s) and the amount(s) thereof are chosen, such that the rheology profile above is met. In a preferred embodiment the rheology modifying agent(s) comprise at least one viscosity agent and at least one heat-activable gelling agent. Viscosity agents refer to agents that increase the viscosity of a solution, typically with a higher increase of the loss modulus than of the elastic modulus. Gelling agents refer to agents that increase the gel force of a solution, typically with a higher increase of the elastic modulus than of the loss modulus.

Thus in a preferred embodiment, the aqueous gelling matrix or gelled matrix typically comprises:
water;
at least one viscosity agent, and
at least one heat-activable gelling agent.

The matrix comprises water. Water is typically present in an amount of from 10% to 95%, by weight of the matrix, preferably from 30% to 80%. It is mentioned that a part of the water can come from ingredients used to prepare the matrix, for example from fruits or fruit extracts or from premix solutions or dispersions.

Heat-activable gelling agents are known. Examples include carrageenans, preferably kappa-carrageenans, locust bean gum (LBG), low methylated pectins, low methylated aminated pectins, or gelatin. In a preferred embodiment the matrix comprises a carrageenan and a locust bean gum (LBG), preferably in a ratio carrageenan/LBG of from 10/90 to 90/10, preferably 50/50 to 85/15, preferably 66/33 to 80/20. The heat activable gelling agent can be present in an amount of from 0.10% to 2.00% by weight, preferably 0.20% to 1.00% of the total weight of the matrix. The heat-activable gelling agent(s) and/or amount(s) thereof mentioned above provide an interesting gelling capacity, and/or an interesting heat-activation temperature that allows an efficient processing, and/or an interesting gelling speed capacity, and/or an improved fruit suspension.

Viscosity agents are known. Examples include starches, galactomannans such as guar gums, xanthan gums, and pectins different from low methylated pectins, for example high methylated pectins. In a preferred embodiment the matrix comprises a starch and a guar gum, preferably in a ratio starch/guar gum of from 50/50 to 95/5, preferably 75/25 to 90/10. The viscosity agents(s) can be present in an amount of from 0.50% to 3.00% by weight, preferably 1.00% to 2.00% of the total weight of the matrix. The viscosity agent(s) and/or amount(s) thereof mentioned above provide an interesting stabilizing capacity of the gelling matrix or composition before processing (upon storage for example) and/or an interesting pump ability, and/or an interesting rheology (viscous enough) avoiding projection upon dosing the other composition at step e), preferably at a temperature between T₂ and T_{f}.

In a preferred embodiment the gelling or gelled matrix comprises, preferably in amounts mentioned above:
as viscosity agent(s): a starch and optionally a guar, and
as heat-activable gelling agent(s): a carrageenan and optionally a locust bean gum.

In a preferred embodiment the gelling or gelled matrix comprises as viscosity and/or heat-activable gelling agents, starch, carrageenan, locust beam gum, and guar, preferably in amounts mentioned above.

Organoleptic modifiers are known by the one skilled in the art. The organoleptic modifiers can be for example sugars, sweetening agents different from sugar, coloring agents, cereals and/or cereal extracts, or flavors.

Examples of sweetening agents are ingredients referred to as High Intensity Sweeteners, such as sucralose, acesulfamK, aspartam, saccharine, rebaudioside A or other steviosides or stevia extracts.

Other ingredients for example include pH modifiers, colorants and nutritional ingredients such as minerals, vitamins or fibers. The matrix can for example comprise citric acid. The pH of the composition is preferably of from 3.0 to 5.0, preferably from 3.4 to 4.2, preferably from 3.3 to 4.0.

### Other Composition

The other composition can be any food composition constituting an upper layer. It is typically a composition different from the composition of the lower layer. The difference can be a difference in the ingredients, and/or a difference in the rheology. Preferably the other composition has a lower gel strength than the gel strength of the lower layer.

The other composition can be for example a liquid or viscous fluid. Examples of other compositions include for example beverages, soups, curds, creams and/or milk-based products.

The other composition is preferably a dairy product, preferably a fermented dairy product. The dairy product is typically in the form of a dairy mass (also referred to as white mass). It is noted that although it is not a preferred embodiment some fruits or other pieces can be dispersed in the mass.

The dairy product or mass is typically comprised of milk and/or ingredients obtained from milk. It is also referred to as a “milk-based composition”. Herein milk encompasses also substitutes to animal milk, such as vegetal milk, such as soy milk, rice milk, etc. . . . .

Milk-based compositions useful in such products and/or processes are known by the one skilled in the art of dairy products, preferably fermented dairy products. Herein a milk-based composition encompasses a composition with milk or milk fractions, and compositions obtained by mixing several previously separated milk fractions. Some water or some additives can be added to said milk, milk fractions and mixtures. Herein milk typically refers to animal milk, for example cow milk. Some alternative animal milks can be used, such as sheep milk or goat milk.

The milk-based composition can typically comprise ingredients selected from the group consisting of milk, half skimmed milk, skimmed milk, milk powder, skimmed milk powder, milk concentrate, skim milk concentrate, milk proteins, cream, buttermilk and mixtures thereof. Some water or additives can be mixed therewith. Examples of additives that can be added include sugar, sweeteners different from sugar, fibers, and texture modifiers.

The milk-based composition can typically have a fat content of from 0% to 5% by weight, for example of from 0% to 1% or from 1% to 2% or from 2% to 3% or from 3% to 4% or from 4% to 5%. The “fat content” of a product corresponds to the weight of the fat components present in the product relatively to the total weight of the product. The fat content is expressed as a weight percentage. The fat content can be measured by the Weibull-Berntrop gravimetric method described in the standard NF ISO 8262-3. Usually the fat content is known for all the ingredients used to prepare the product, and the fat content of the product can is calculated from these data.

The milk-based composition can typically have a protein content of from 2% to 6% by weight, for example of from 2% to 3% or from 3% to 4% or from 4% to 5% or from 5% to 6%. The “protein content” of a product corresponds to the weight of the proteins present in the product relatively to the total weight of the product. The protein content is expressed as a weight percentage. The protein content can be measured by Kjeldahl analysis (NF EN ISO 8968-1) as the reference method for the determination of the protein content of dairy products based on measurement of total nitrogen. Nitrogen is multiplied by a factor, typically 6.38, to express the results as total protein. The method is described in both AOAC Method 991.20 (1) and international Dairy Federation Standard (IDF) 20B:1993. Usually the total protein content is known for all the ingredients used to prepare the product, and total protein content of the product is calculated from these data.

The ingredients of the milk-based composition and/or the amounts thereof can be selected thereto.

The dairy product or mass can be for example:
a fermented milk product, for example a yogurt, a fresh cheese, a cheese,
a non-fermented milk-based dessert,
a vegetal milk substitute, for example soy milk, rice milk, oat milk, almond milk or a mixture thereof,
a fermented vegetal milk substitute product, for example a fermented soy product,
a non-fermented vegetal milk substitute dessert, for example a soy dessert,
a frozen dessert, for example an ice-cream, or a frozen yogurt.

In a preferred embodiment the dairy product is a fermented milk product.

The dairy product can be in the form of a liquid drink, a viscous spoonable product, a mousse, or a solid product such as a frozen product. Such dairy products are known by the one skilled in the art.

Desserts, either milk-based or vegetal milk substitute-based are typically heat-treated products, usually comprising gelling agents. They can be for example in the form of a flan, a creme or a mousse.

The dairy product or mass can be a fermented milk product, or a fermented vegetal milk substitute product. Fermented products typically comprise microorganisms, such as lactic acid bacteria and/or probiotics (the probiotics can be lactic acid bacteria), dead or alive. These are also referred to as ferments or cultures or starters. Lactic acid bacteria are known by the one skilled in the art. They include Lactobacilli (Lactobacillus acidophilus, Lb. casei, Lb. plantarum, Lb. reuteri, Lb. johnsonii), certain Streptococci (Streptococcus thermophilus), Bifidobacteria (Bifidobacterium bifidum, B. longum, B. breve, B. animalis) and/or Lactococci (Lactococcus lactis). Probiotics are also known by the one skilled in the art. Examples of probiotics include some Bifidobacteria and Lactobacilli, such as Bifidobacterium brevis, Lactobacillus acidophilus, Bifidobacterium animalis, Bifidobacterium animalis lactis, Bifidobacterium infantis, Bifidobacterium longum, Lactobacillus casei, Lactobacillus casei paracasei, Lactobacillus reuteri, Lactobacillus plantarum, or Lactobacillus rhamnosus. In one embodiment the product is a fermented milk product such as yogurt. It is mentioned that yogurts are considered as being specific fermented milk products.

Fermented products have undergone a fermentation step. The fermentation is typically done by microorganisms such as bacteria and/or yeasts, preferably at least bacteria, preferably lactic acid bacteria, and leads to the production of fermentation products, for example lactic acid, and/or to the multiplication of the microorganisms. The designation “fermented milk” can depend on local legislation, but is typically given to a dairy product prepared from skimmed or full fat milk, or concentrated or powdered milk, having undergone a heat treatment at least equivalent to a pasteurization treatment, and inoculated with lactic acid producing microorganisms such as the bacteria mentioned above.

If the dairy product is a fermented dairy product, it typically comprises lactic acid bacteria. The lactic acid bacteria typically comprise a mixture of Streptococcus thermophilus and Lactobacillus delbrueckii subsp. Bulgaricus.

The fermented milk product can be a set product, wherein fermentation occurs in the container, or a stirred or drink product, wherein fermentation occurs in a tank, prior to dosing in the container. Fermented milk products, before the addition of the composition of the invention, can be referred to as “white masses”. The pH of the white mass and/or of the final food product can be for example of from 3.5 to 5, preferably from 4 to 5, preferably from 4.2 to 4.9.

The dairy product might comprise some additives, such as organoleptic modifiers, colorants, viscosity and/or texture agents.

### Process

The process of the invention involves the following sequential steps:

Step a) providing the heat-activable gelling composition at a temperature T₀,
Step b) heating the heat-activable gelling composition to a temperature T₁>T₀, to activate gelling,
Step c) cooling the composition to a temperature T₂,
Step d) dosing a volume of the activated composition in the container at temperature T₂, to obtain a lower layer,
Step e) dosing a volume of another composition in the container, to obtain an upper layer,
Step f) optionally further cooling to a final temperature T_{f}, and/or allowing a gelling time, to obtain a lower layer gelled composition.

At step a) the heat-activable gelling composition is provided. Such compositions are described above. The composition can be prepared on site before processing, and optionally stored into a tank, for example at temperature T₀. In another embodiment the composition is prepared on another site, transferred to the production site, typically in a tank at temperature T₀. Temperature T₀ is typically a chilled temperature allowing preservation of the composition, for example of from 1° C. to 15° C., preferably from 4° C. to 11° C., for example about 10° C.

At step b) the composition is heated to a temperature T₁>T₀. This step allows the activation of the gelling capacity of the composition. Typically T₁>T_{Act}, preferably T₁>T_{Act}+5° C.

In a preferred embodiment, that allows saving energy, 40° C.<T₁<80° C., preferably 45° C.<T₁<60° C. Step b) can be performed by heating the composition in a tank used to provide the composition, for example a storage tank. In another embodiment step b) is performed in a heat exchanger, preferably in a tubular or scrapped heat exchanger.

At step c) the gelling composition is cooled to a temperature T₂. It is mentioned that T₂<T₁. Step c) can be performed in a tank, for example the tank used to provide and heat the composition or another tank such as a holding tank arranged to allow the temperature to decrease, or in a heat exchanger, preferably in a tubular or scrapped heat exchanger.

Temperature T₂ is preferably such that G′_{T2}<G′_{T0}, wherein G′_{T2} is the elastic modulus at temperature T₂ upon cooling. Preferably T₂>T_{Trans}, preferably T₂>T_{Trans}+5° C. Upon cooling to temperature T₂ the viscosity typically increases. T₂ is preferably such that the viscosity at this temperature allows pumping, for example with a viscosity of lower than 1500 mPa·s. In a preferred embodiment the viscosity is high enough to avoid projections of the composition when the other composition is dosed at step e). Preferably V_{T2}>650 mPa·s, preferably V_{T2}>750 mPa·s, wherein V_{T2} is the viscosity at temperature T₂.

In a preferred embodiment 20° C.<T₂<40° C.

At step d) a volume of the gelling composition is dosed in the container at temperature T₂. Such dosing operations are known by the one skilled in the art. These are typically done such that the composition does not project on the interior of the upper part of the side walls. This step results in a lower layer of the gelling composition located in the bottom of the container. The dosing of the gelling composition is typically performed in a timing of from 0.1 seconds to 5 seconds.

At step e) the other composition is dosed. Such dosing operations are known by the one skilled in the art. Preferably this dosing step is performed at high sequential speed. The time between step d) and step e) is preferably of at most 15 seconds, preferably at most 10 seconds. This allows a high productivity. The other composition is typically prepared on processing site. It can be dosed at any appropriate temperature, with or without a cooling step after before dosing. In one embodiment the other composition dosed at step e) has a temperature of from 10° C. to 45° C. The dosing of the other composition results in an upper layer of the other composition, typically located in the container on top of the gelling or gelled composition.

In one embodiment the viscosity at temperature T₂ is quite high and avoids projections of the gelling composition when the other composition is dosed at step e), preferably within a timing of at most 15 seconds, preferably at most 10 seconds. In this embodiment step e) can be performed directly. At this stage and temperature, it is possible that the gelling composition has not developed into a gel yet.

In one embodiment a cooling step d′) to a temperature T₃ is implemented before step e). It is mentioned than T₂>T₃. For example T₂>T₃+5° C., for example 15° C.<T₃<35° C. This step is typically implemented between the first dosing step d) and the second dosing step e). Such a step d′) can be typically implemented if the viscosity at temperature T₂ is not quite high and does not allow avoidance of projections of the other composition. Preferably the viscosity at temperature T₃ is high and avoids projections of the composition when the other composition is dosed at step e). Preferably V_{T3}>650 mPa·s, preferably V_{T3}>750 mPa·s, wherein V_{T3} is the viscosity at temperature T₃. Step d′) is preferably within a timing of at most 15 seconds, preferably at most 10 seconds. At this stage and temperature, it is possible that the gelling composition has not developed into a gel yet. In a specific embodiment cooling step d′) is implemented by applying a liquefied gas, preferably nitrogen. The liquefied gas is typically introduced in the container via a conduct and allows a quick cooling of the surface and even a freezing of the surface.

The process can comprise a step f) of further cooling to a final temperature T_{f}, and/or allowing a gelling time, to obtain a gelled composition. The final temperature is typically a storage temperature, preferably of from 4° C. to 10° C. for a chilled product, such as a product comprising a fermented dairy composition. Cooling to final temperature T_{f} can be for example performed by holding and/or storing at this temperature. Holding and/or storing the product obtained, and optionally cooling, typically allows the gelling to be completed. Thus the lower layer typically reaches its final rheology and/or texture during step f), for example within a time of from 5 to 60 minutes.

Further details or advantages of the invention might appear in the following non limitative examples.

### EXAMPLES

### Example 1—Fruit Gelling Compositions

Some fruit gelling compositions are prepared. Then they undergo heating and cooling steps. Rheology at various stages is evaluated.

The procedure for preparing the fruit compositions is detailed below. The compositions are given in table I below (as weight %).

TABLE I

| | Example | Example 1b |
|---|---|---|
| | 1a | Comparative |
| Pear cubes, 10 mm | 40.50 | 40.5 |
| Citric Acid | 0.15 | 0.15 |
| Sodium citrate | 0.05 | 0.05 |
| Sugar | 15.03 | 15.03 |
| Modified starch Tapioca Frigex HV, Ingedion | 1.17 | 1.80 |
| Carrageenana Genulacta P100, CP Kelco | 0.34 | 0.00 |
| Pectin LM102, CP Kelco | 0.00 | 0.40 |
| Locust Bean Gum | 0.12 | 0.00 |
| Guar gum | 0.23 | 0.25 |
| Flavour | 0.06 | 0.06 |
| Water | 42.35 | 41.76 |

### Procedure

Preparing a fruit mix by mixing fruit, sugar, water, and acidity correctors,
Adding the rheology agents (modified starch, carrageenan, locust bean gum, pectin and/or guar gum),
Pasteurizing (90° C./5 min),
Adding color and/or flavor,
Cooling to 10° C.

### Heating and Cooling Steps and Rheology Evaluations

The fruit compositions are subjected to the following steps:
Heating from 10° C. to 50° C. with a ramp of 2° C. increase per minute, then
Cooling from 50° C. to 4° C. with a ramp of 2° C. decrease per minute.

### Rheology Evaluations

Various rheology evaluations are carried out during heating and/or cooling, on the compositions with fruits or without fruits. For the compositions with fruits, the evaluations are performed directly on the compositions of table I. For the compositions without fruits, the evaluation is performed on the gelling matrix, obtained by filtering the compositions of table I at 20° C. on a 5 mm sieve, to remove the fruit pieces.

The results are reported on table II below.

Viscoelasticity: Elastic Modulus (G′) and Loss Modulus (G″) are evaluated at various temperatures during heating and cooling, in Rheometer MCR30, set at oscillary test with an amplitude of 0.05% and constant frequency of 1 Hz (very low shear). The results are shown on FIG. 1a for composition of example 1a without fruit and FIG. 1b for composition of comparative example 1b without fruit.
Gel strength: analysis performed with TA.XT2 texture analyzer, with the following settings:
Speed before analysis: 0.5 mm/s
Speed during analysis: 1 mm/s
Speed after analysis: 10 mm/s
Length: 4 mm
Time: 30 s
Strength mini: 0.5 g
T° C.: 10° C.
   Viscosity: analysis performed with Rheomat RM 200 (Module 1 and Cylinder 1, shear of 64 s⁻¹ after 10 s).

TABLE II

| Step and | | Example | Example 1b |
|---|---|---|---|
| Temperature | | 1a | (comparative) |
| Start 10° C. | G′ (Pa) - without fruit | 327 | 364 |
| | G″ (Pa) - without fruit | 106.5 | 92.9 |
| | Viscosity (mPa · s) - | 1069 | 1376 |
| | without fruit | | |
| Heating 50° C. | G′ (Pa) - without fruit | 90 | 146 |
| | G″ (Pa) - | 32.3 | 38.8 |
| | without fruit | | |
| | Viscosity (mPa · s) - | 761 | 475 |
| | without fruit | | |
| Cooling 35° C. | G′ (Pa) - without fruit | 102 | 171 |
| | G″ (Pa) - without fruit | 36.3 | 42.9 |
| | Viscosity (mPa · s) - | 801 | 633 |
| | without fruit | | |
| Cooling 10° C. | G′ (Pa) - without fruit | 445 | 248 |
| | G″ (Pa) - without fruit | 98.8 | 67 |
| | Gel Strength (g) - | 51 | 11 |
| | without fruit | | |
| | Gel Strength (g) - with fruit | 73 | 26 |
| Cooling 4° C. | G′ (Pa) | 474 | 289 |
| | G″ (Pa) | 110.5 | 74.6 |

### Example 2—Preparation of Layered Products

One prepares products having a lower layer of a gelled fruit composition and an upper layer of a fermented milk composition packaged in a cup.

Cup: transparent cup, having a circular bottom of 70 mm diameter, conical side walls, a circular opening of 85 mm, and a height of 55 mm.

Fermented milk composition: stirred sweetened fermented milk having a viscosity of 900 mPa·s (10° C., 64 s⁻¹).

### Procedure/Process

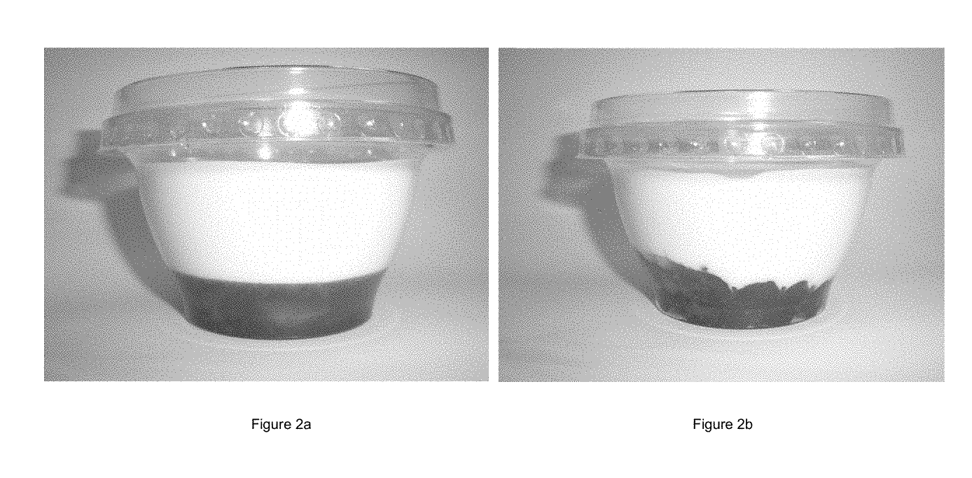

a) The fruit composition is provided, at a temperature of 10° C., in a tank,
b) The fruit composition is transferred in a first heat exchanger and heated to 50° C., in 10 minutes,
c) The fruit composition is transferred in a second heat exchanger and cooled to 35° C., in 5 minutes,
d) 37.5 g of fruit composition is dosed at 35° C. in the yogurt cup,
e) after 8 seconds 87.5 g of fermented milk composition is dosed at 20° C.,
f) the cup is sealed, allowed to cool to 4° C., and stored at 4° C.
Evaluations with Fruit Composition of Example 1a
A picture is presented on FIG. 2a.
The upper part of the cup (where the fermented milk composition is located) does not present any fruit composition projection.
The interface between the lower layer (fruit composition) and the upper layer (fermented milk composition), visible through the transparent cup, is substantially plane (variation of height of interface of at most 5 mm).
The lower layer has a gel texture, presenting some perceivable resistance when a spoon meets it.
The lower layer is a brittle gel melting in mouth, with the fruit pieces being perceived in mouth. The firmness of the fruit pieces is not degraded.
During a shelf life of 35 days at a chilled temperature of from 4° to 10° C., the gel strength of the lower layer shows an acceptable increase (up to twice the gel strength of day 1).
   Evaluations with Fruit Composition of Comparative Example 1b
A picture is presented on FIG. 2b.
The interface between the lower layer (fruit composition) and the upper layer (fermented milk composition), visible through the transparent cup, is not substantially plane (variation of height of interface of higher than 10 mm).
The lower layer is not a gel.

1-17. (canceled)

18. A process for preparing a product comprising a container and in the container a food composition comprising a gelled composition comprising a gelled matrix and optionally fruit, preferably in the form of fruit pieces, said process comprising the following steps:
Step a) providing a heat-activable gelling composition comprising a heat-activable aqueous gelling matrix composition and from 0 to 180 parts by weight of fruit, for 60 parts by weight of the heat-activable aqueous gelling matrix, at a temperature T₀,
Step b) heating the heat-activable gelling composition to a temperature T₁>T₀, to activate gelling,
Step c) cooling the composition to a temperature T₂,
Step d) dosing a volume of the activated composition in the container at temperature T₂, to obtain a lower layer, and
Step e) dosing a volume of another composition in the container, to obtain an upper layer.

19. A process according to claim 18, wherein:
G′_{Tf}/G″T_{Tf}≧4,
wherein G″_{Tf} is the loss modulus at final temperature T_{f} after cooling.

20. A process according to claim 18, wherein
V_{T2}>650 mPa·s
wherein V_{T2} is the viscosity at temperature T₂.

21. A process according to claim 18, wherein
G′_{T0}/G″_{T0}<4,
wherein G′_{T0} is the elastic modulus at temperature T₀ before heating, and G″_{T0} is the loss modulus at temperature T₀ before heating.

22. A process according to claim 18, wherein
(G′_{Tf}/G″_{Tf})/(G′_{T0}/G″T₀)≧1.2,
wherein G″_{Tf} is the loss modulus at final temperature T_{f} after cooling and G″T0 is the loss modulus at temperature T0 before heating.

23. A process according to claim 18, wherein:
40° C.<T₁<80° C.

24. A process according to claim 18, wherein the time between step d) and step e) is of at most 15 seconds.

25. A process according to claim 18, wherein:
G′_{T2}<G′_{T0}
wherein G′_{T2} is the elastic modulus at temperature T₂ upon cooling.

26. A process according to claim 18, wherein:
20° C.<T₂<40° C.

27. A process according to claim 18, wherein a cooling step d′) to a temperature T₃ is implemented before step e).

28. A process according to claim 27, wherein the cooling step d′) is implemented by applying a liquefied gas.

29. A process according to claim 18, wherein the heat-activable aqueous gelling matrix comprises:
water,
at least one viscosity agent, and
at least one heat-activable gelling agent.

30. A process according to claim 29, wherein:
the viscosity agent(s) comprise(s) starch and optionally guar, and
the heat-activable gelling agent(s) comprise(s) carrageenan and optionally locust bean gum.

31. A process according to claim 29, wherein the viscosity and/or heat-activable gelling agents comprise starch, carrageenan, locust beam gum, and guar.

32. A process according to claim 18, wherein the other composition dosed at step e) is a fermented dairy product.

33. A process according to claim 18, wherein the other composition dosed at step e) has a temperature of from 10° C. to 45° C.

34. A process according to claim 18, wherein the food composition has:
at the bottom of the container a lower layer of a gelled composition comprising an aqueous gelled matrix composition and from 0 to 180 parts of fruit, for 60 parts of the aqueous gelled matrix, and
above the lower layer, another composition.

35. The process of claim 18, wherein the heat-activable gelling composition comprises 20 to 90 parts by weight of fruit.

36. The process of claim 35, further comprising:
Step f) further cooling to a final temperature T_{f}, and/or allowing a gelling time, to obtain a lower layer gelled composition,
wherein:
the heat-activable aqueous gelling matrix composition is such that:
G′_{Tf}>G′_{T0}
wherein G′_{T0} is the elastic modulus before heating, at temperature T₀, and G′_{Tf} is the elastic modulus at final temperature T_{f} after cooling.

37. The process of claim 20, wherein V_{T2}>750 mPa·s.
